(19) United States
(12) Patent Application Publication
(10) Pub. No.: US 2008/0185549 A1
(43) Pub. Date: Aug. 7, 2008

(54) Differential valve

(76) Inventors: Herman J. Steinbuchel, Upland, CA (US); Michel Glukhov, Tarzana, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/701,820

(22) Filed: Feb. 2, 2007

(51) Int. Cl. F16K 5/10

(52) U.S. Cl. 251/205

(57) ABSTRACT

A differential valve assembly that maintains an outlet pressure at a predetermined difference from an inlet pressure. It can be used to keep a large vehicle frame horizontal despite a permanent extra load on a first side of the frame. In that case, the system includes a simple air refill valve device (52) that connects a pressured air supply S to the first air bag (12), to vary the first air bag pressure so as to maintain the frame at a predetermined height above a location on the axle. The system also includes a differential valve assembly (54) that includes a first valve (72) that can fill the second air bag if its pressure is too low, and a second valve (80) that can vent the second air bag to the atmosphere if the second air bag pressure is too high.

### BACKGROUND OF THE INVENTION

Large vehicles commonly use a pair of air bags on opposite sides of each axle, to support the vehicle frame on the vehicle axle while absorbing shocks. Each air bag should be maintained at a predetermined height, and each air bag pressure is normally increased when a load is temporarily placed in the vehicle. Sometimes a permanent or semipermanent load is placed on only one side of the vehicle frame, such as where a heavy accessory is placed on one side or the cab design results in a lopsided load. In that case, the air pressure in the air bag on the heavily loaded side must be increased to maintain the predetermined air bag heights. One type of prior art system for maintaining air bag height in such a situation includes a separate air refill valve for each of the two air bags, with each refill valve being controlled by a separate linkage that indicates changes in a corresponding air bag height. A lower cost system that involved only one linkage, would be of value.

### SUMMARY OF THE INVENTION

In accordance with one embodiment of the invention, applicant provides a differential valve system that is useful for a vehicle wherein the vehicle frame is supported on each vehicle axle by a pair of air bags, and wherein one side of the frame may be permanently or semipermanently loaded more than the other side, which requires only one height-indicating linkage and which is of only moderate cost. The system includes a single refill valve device with a single linkage, that controls air pressure in a first airbag to maintain the vehicle frame at a predetermined constant height above a location on the axle. The system also includes a valve assembly that connects the second air bag of the pair to the first one. The valve assembly includes a first valve that can deliver air from the first air bag to the second one to assure that the second air bag pressure is not too low. The valve assembly also includes a second valve that vents air from the second air bag to the atmosphere when the second air bag is overinflated to assure that the second air bag pressure is not too high. Preloaded springs in the valves assure that a predetermined pressure difference (e.g. 20 psi) is maintained between pressures in the first and second air bags.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a simplified front elevation view of a prior art air bag inflation system.

FIG. 2 is a simplified front elevation system of another prior art air bag inflation system.

FIG. 3 is a simplified front elevation view of an air bag inflation system of the present invention.

FIG. 4 is a sectional view of a differential valve assembly of the present invention which is part of the system of FIG. 3.

FIG. 5 is a sectional view of a valve assembly of another embodiment of the invention with both valves closed.

FIG. 6 is a sectional view of the valve assembly of FIG. 5, with the first valve open.

FIG. 7 is a sectional view of the valve assembly of FIG. 6 with only the second valve open.

FIG. 8 is a sectional view of another embodiment of the system.

### DESCRIPTION OF THE PREFERRED EMBODIMENTS

FIG. 2 illustrates one prior art leveling system 10 wherein a vehicle frame 15 is supported on a vehicle axle 16 by two air bags 12, 14 that each supports one side of the frame on one side or end portion 17, 18 of the axle. The pressure of air in each air bag is controlled by a separate valve 20, 22 that assures that the corresponding air bag 12, 14 is always of a predetermined height, such as 15 inches, so the frame lies that height above a corresponding axle location. Each valve 20, 22 controls the flow of air from a pressured air source S to one of the two air bags 12, 14 and also controls the exhaust of air from the corresponding air bag (when the air bag height is more than the desired height). Each valve is connected by a linkage 32, 34 to a corresponding end portion of the axle, and the height of the top of the linkage with respect to the frame determines valve operation. This system maintains a level (horizontal) vehicle frame even when one side of the vehicle is more heavily loaded than the other side, and also avoids “pumping” (random small flows of air between air bags at opposite sides of a vehicle axle). A disadvantage of this system is that it uses two valves that are each complicated, especially because each valve requires a separate linkage to indicate the height of its corresponding air bag.

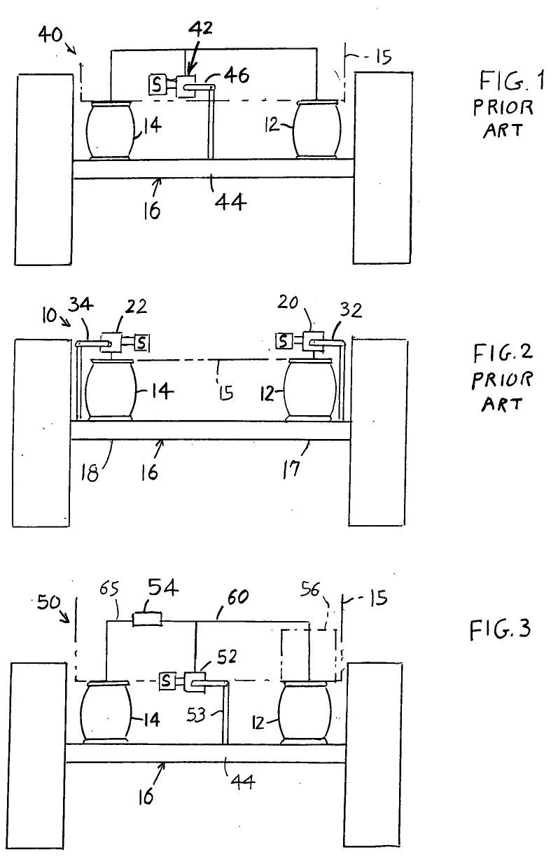

FIG. 1 illustrates another prior art leveling system 40 which is simple and of low cost. The system 40 uses a single valve 42 with a linkage 46 that indicates the height of the frame 15 above a middle 44 of the axle 16 (i.e. it indicates the average height of the two air bags). A disadvantage of this system is that it allows the frame to lean as a result of one air bag having a significantly different height than the other air bag because one side of the frame is more heavily loaded than the other side. This system also allows pumping (random small flows of air between air bags, which wastes pressured air). The valve 42 flows air between the pressured air source S and the two air bags and exhausts the two air bags, simultaneously. The valve is controlled by the height of the middle 44 of the axle, which determines the height of the top of the linkage 46 relative to the frame.

FIG. 3 illustrates a system 50 of the present invention, which uses a single refill valve device 52 that includes a single linkage 53 that indicates the height of a location along the axle such as the height at the first air bag 12 or the height of the middle 44 of the axle 16. The refill valve device flows air into the first air bag 12 when its height (or the height of the frame above the middle of the axle) is below a preset level. However, instead of applying the same air pressure to both air bags as does the system 40 of FIG. 1, the system 50 of FIG. 3 applies different air pressures to the two air bags 12, 14 to compensate for the substantially permanent extra load 56 on one side of the frame.

The system 50 includes not only the refill valve device 52 but a single load balancing valve assembly 54. The assembly 54 maintains the two air bags 12, 14 at the same heights in a situation where one side of the frame such as a first side that is supported by the first air bag 12, is permanently or semipermanently more heavily loaded by a given amount than the other side of the frame which is supported by the second air bag 14. FIG. 3 shows an additional load 56 on the first air bag 12. Some examples of such loading are where the vehicle engine is placed on one side, where heavy accessories are placed on one side, and where the cab or truck body design results in more weight on one side. Applicant's use of a single refill valve device with a single linkage, together with the load balancing valve assembly which has no linkage, reduces the cost of the leveling system including the cost of installation, while maintaining a level frame for a predetermined unequal loading and while avoiding pumping.

The simple refill valve device 52 maintains an air pressure (e.g. 60 psi when there is no extra load in the vehicle) in the air bag 12 that is the one that is more heavily loaded, by flowing air from the source S that is at a high pressure (e.g. 120 psi) into the first air bag to maintain the frame height above a location (e.g. the middle) on the axle. The refill valve 52 is opened for very short periods of time, so the air in conduit 60 that connects the air bag 12 to the load balancing valve assembly 54 is almost always at a pressure equal to the air pressure in the first air bag 12. The load balancing valve assembly 54 maintains a predetermined lower pressure (e.g. 20 psi lower) in the second air bag 14 than in the first air bag, to assure that the two air bags are of about the same height despite the large load on the first air bag 12. The load balancing valve also exhausts air to the environment, or atmosphere, to avoid overpressure in the air bags.

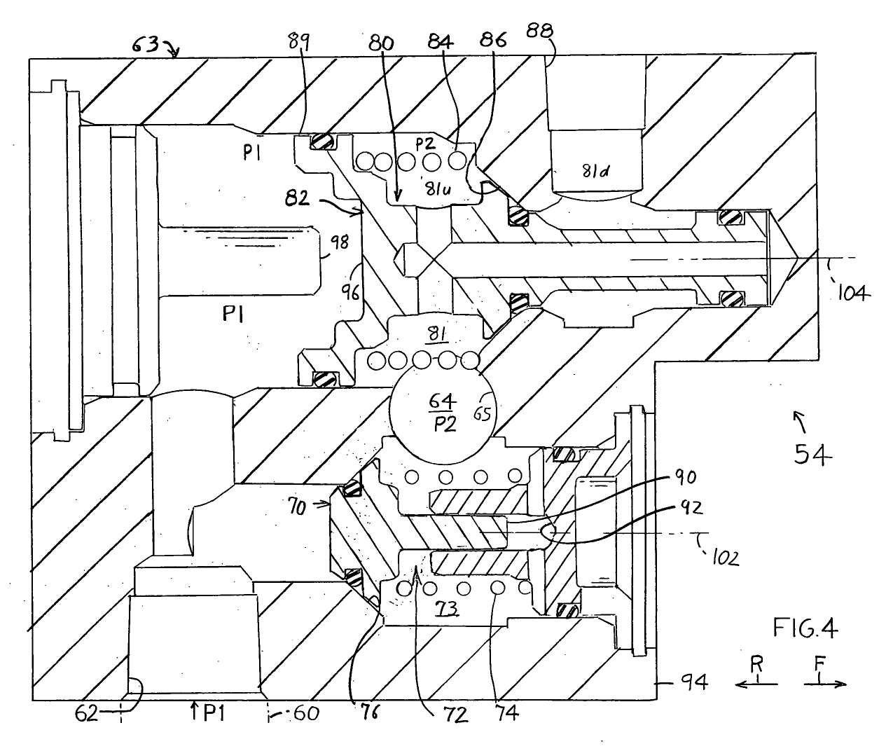

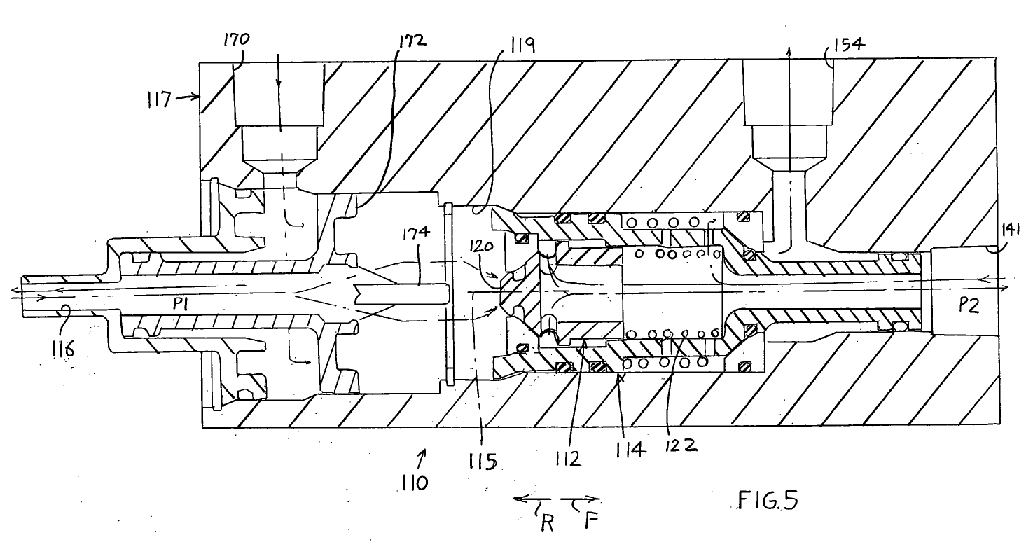

FIG. 4 is a sectional view of one embodiment of the differential, or load balancing valve assembly 54 which senses the pressure P1 (e.g. 60 psi) in the first air bag, and which maintains a proper pressure P2 (e.g. 40 psi) in the second air bag. The first air bag is connected through the first conduit 60 to a first port 62 in a housing 63 of the valve assembly 54. The valve assembly has a second port 64 that is connected through a second conduit 65 to the second air bag. The pressure P1 from the first air bag presses against a first valve member, or poppet 70 to push it in a forward F direction, away from a first valve seat 76 to tend to open the first valve seat of the first valve 72. A first valve spring 74 urges the poppet in the rearward direction R with sufficient force that the first valve 72 will open only when the pressure P1 is at least a predetermined amount (e.g. 20 psi) greater than the pressure P2 in the second air bag. Assuming that a load is placed symmetrically in the vehicle frame so the first air bag pressure P1 increases (e.g. to 65 psi) and so the pressure P2 in the second air bag is below the desired level (e.g. 45 psi). In that case, the first valve 72 will open, and air flows along a first passage 73 to the second air bag to fill it with air until it reaches the proper pressure (45 psi). Although examples of proper pressure are given these pressures vary, with the first pressure P1 varying in order to maintain the frame at the desired height above the middle of the axle or maintain the height of the first air bag, and with the second pressure P2 varying to maintain the second air bag pressure P2 at a predetermined pressure below the pressure P1.

At times, the air pressure P1 (e.g. 60 psi) in the first air bag will exceed the pressure (e.g. 55 psi) needed to maintain the frame at the desired height above the axle (at the middle or at the first air bag), as when a load is removed from the vehicle frame. This also can happen when the air bag temperature rises, or when the vehicle repeatedly moves over road bumps that cause the refill valve to repeatedly flow small quantities of air to the first air bag. The refill valve device 52 (FIG. 3) will then exhaust air from the first air bag into the atmosphere to maintain the desired separation of frame and axle, or the desired bag height. If the pressure P2 in the second air bag is too high so the difference P1−P2 is less than the desired difference (20 psi) then the excess air in the second bag will be exhausted to the atmosphere through a discharge, or exhaust passage 81 of a second valve 80 (FIG. 4) of the load balancing valve assembly. The first pressure P1 urges a second valve member, or poppet 82 to move in the forward direction F against a second valve seat 86 to keep the second valve closed. However, the second air bag pressure P2 and the air pressure equivalent (20 psi) of a second spring 84 urges the second poppet to move in the rearward R direction to open the second valve. If the second pressure P2 is greater than the desired level (20 psi below P1), then the second valve opens to allow air to flow through upstream and downstream passage portions 81u, 81d, to exhaust air from the second valve through exhaust port 88 to the atmosphere. Air at pressure P1 cannot flow to the atmosphere because the second poppet has a sealed upstream portion 89. The air pressure equivalent of a spring is the air pressure required to obtain the same effect as the preloaded spring.

Where the second spring 84 is preloaded to exert a force equivalent of 20 psi, it allows the second valve to open at a pressure difference of 20 psi. This assures that the second valve will start to exhaust air when the air pressure difference P1−P2 is less than 20 psi. For example, if P2 increases to 41 psi while P1 remains at 60 psi, the second valve 80 will open until P2 falls to 40 psi. In actuality, the springs are chosen so there is a dead zone such as where P2 ranges from 19.6 to 20.4 psi below P1, during which neither valve 72 nor 80 will open. This can be done by preloading the first valve spring 74 so the first valve opens at a pressure difference P1−P2=39.6 psi and by preloading the second spring 84 so the second valve opens at a pressure difference of P1−P2=40.4 psi. A mechanism can be provided to vary the preload of one or more of the springs.

When the first valve 72 opens, the first poppet 70 normally moves very slightly forward F, but forward movement is limited by a post 90 on the first poppet abutting a stop location 92 on the valve housing 94. When the second poppet 82 opens, it normally moves very slightly rearward R, but its rearward movement is limited by a surface 96 of the second poppet abutting a stop location 98 on the valve housing.

In the load balancing valve assembly 54 of FIG. 4, the first and second poppets 70, 82 move along spaced axes 102, 104. FIG. 5 shows a valve assembly 110 wherein the first and second poppets 112, 114 move along coincident axes 115, and with the first poppet lying within the second one. This reduces the amount of space and cost of the load balancing valve assembly. The housing 117 forms a housing passage 119 that connects first and second ports 116, 141 respectively to the first and second air bags. The valve assembly 110 lies along the housing passage.

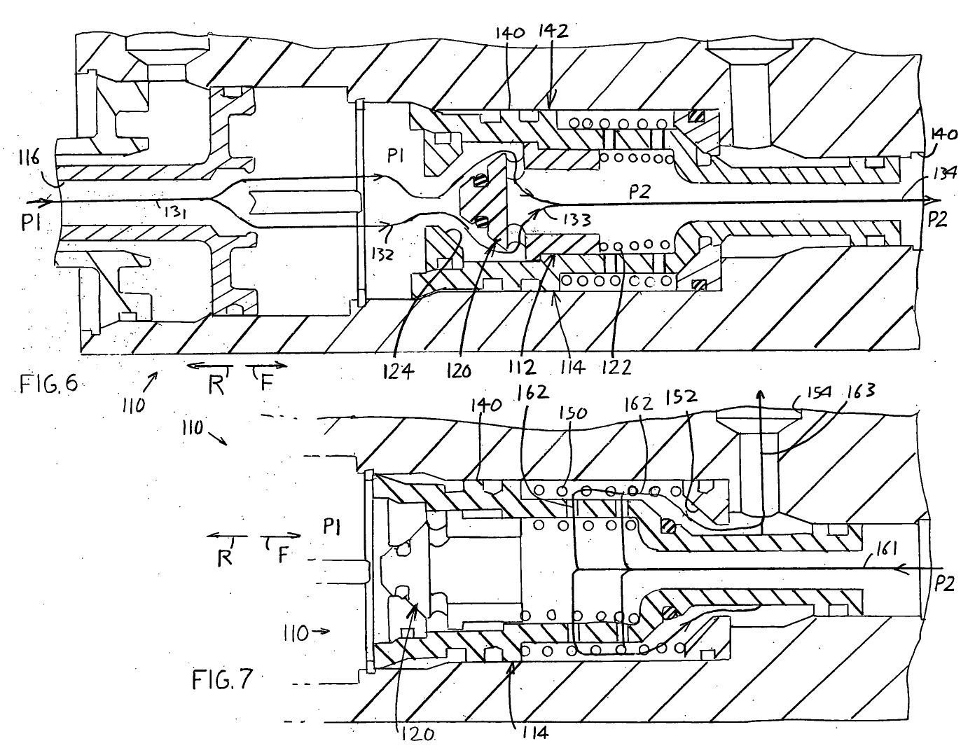

As shown in FIG. 6, air at pressure P1 can enter port 116 in the valve assembly housing 117 and press the first poppet 112 of the first valve 120 forward to slide it along a second poppet passageway 121. The first poppet 112 slides forward F to open the first valve, against the force of a first spring 122 plus the force of air at pressure P2. If the pressure P1 increases (e.g. because the refill valve device increases P1 when a load is added to the vehicle frame) the first valve 112 opens and air flows through port 141 into the second air bag to increase the pressure P2. If the pressure P1 decreases (because the refill valve device senses that a load is removed from the vehicle frame) then the second valve 114 opens to allow air to escape from the second air bag through port 154 to the atmosphere to lower pressure P2.

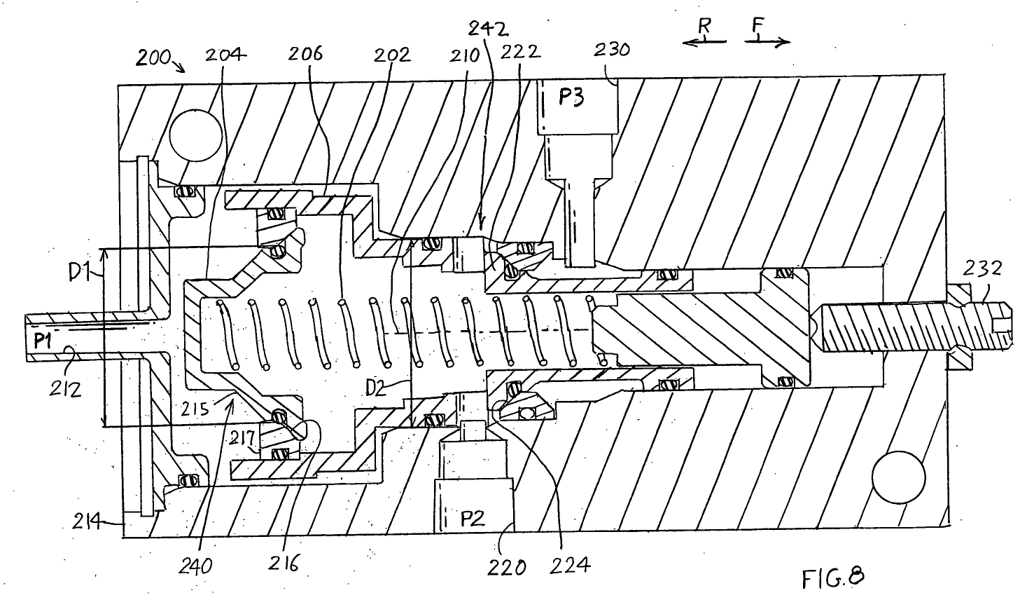

FIG. 7 shows the assembly 110 when the pressure P1 has decreased (e.g. by a load being removed from the vehicle frame) so P2 is too high because the pressure difference (20 psi) is less than the desired level, and air is to be vented from the second air bag into the atmosphere. The high pressure P2 causes the second poppet 140 of the second valve 114 to move rearward R away from the second valve seat 152. Air from the second air bag then is exhausted through the open second valve and out through an exhaust port 154 and flows along paths 161-163.

FIG. 5 shows that the load balancing valve 110 has a fourth port 170 that can receive pressured air resulting in the ports 116, 141 being connected together so air can freely flow between the two air bags. This facilitates initial filling of the bags, such as after repair work has been performed. It is also useful where a heavy accessory on one side has been removed, When a pressure (e.g. above 70 psi) is applied to the fourth port 170 which is sufficient to overcome the force of the spring 122, a control member 172 moves forward and its post 174 moves the first poppet 120 forward to open the first valve. The first valve remains open and connects the two ports 116, 141 and therefore connects the two air bags to quickly fill them and initially equalize their pressure.

FIG. 8 illustrates another differential valve assembly 200 which includes a single spring 202. The assembly includes first and second valve members or poppets 204, 206 that move along axis 210. Air at pressure P1 can enter inlet port 212 that is formed in a valve assembly housing 214. The pressure P1 presses rear faces 215, 217 of both poppets 204, 206 forward F. In one example, at a pressure P1 of 60 psi acting on an area of diameter D1, the preload of the spring 202 results in the first poppet 204 abutting a first valve seat 216 formed on the second poppet 206. The pressure P2 in an outlet port 220 leading to an air bag is 20 psi below P1, so P2 equals 40 psi. The spring 202 acting over an area of diameter D1, produces a force equivalent to a pressure of 20 psi. The pressure of 40 psi on poppet 204 plus the force of the spring 202 keeps the first poppet 204 closed against the first valve seat 216.

If the pressure P1 increases to 61 psi, the poppet 204 opens (moves forward F relative to poppet 206) and remains open until bag pressure P2 increases to 41 psi, and then closes (moves rearward R).

The forward pressure on the second poppet 206 is the area D2 times pressure P1. If the pressure P1 decreases to 59 psi, the first poppet 204 valve seat 216 remains closed, but the second poppet 206 moves rearward R under the force of the spring which is opposed by pressure P1 over area D2. Then a front portion 222 of the second poppet moves rearward away from a second valve seat 224. This allows air from the outlet, or air bag port 220 to flow into an exhaust port 230 at pressure P3. P3 is usually zero because port 230 usually leads to the environment. Air flows into the environment until air bag pressure P2 reaches 39 psi. Then, the second poppet front portion 222 moves forward and closes against the second valve seat 224.

The preload of the spring 202 can be increased or decreased by turning a set screw 232. If the spring is compressed further, so its preload increases from e.g. 20 psi to 21 psi equivalent, then this increases the pressure difference to 21 psi so when P1 is 60 psi P2 is 39 psi, and the valve seats 216, 224 will open and close to maintain this difference. In the valves of FIGS. 4 and 5, the preload of two springs has to be adjusted to change the pressure difference. In FIG. 8, turning the set screw 232 moves a plunger 242 rearward or allows it to move forward under the face of the spring 202.

In the system of FIG. 8, a first valve 240 that flows air from the inlet port 212 at P1 to the outlet port 220 at P2, is formed by a first poppet 204 that moves against and away from a valve seat 216 on a moveable second poppet 206. A second valve 242 that flows air from the outlet port 220 at P2 to the exhaust port 230 is formed by the second poppet 206 and a stationary second valve seat 224. The second poppet 206 which carries the movable first valve seat, has a portion that moves against and away from the fixed second valve seat. A single spring 202 biases the first poppet rearward against pressure P1 at a diameter D1 to maintain a pressure difference P1−P2, and biases the second poppet 206 against a pressure P1 on a diameter D2 that maintains a pressure difference P2−0, with P2 controlled by P1.

Thus, the invention provides a differential valve assembly which is useful for a vehicle air bag suspension system of relatively low cost that avoids vehicle tilt when only one side of the vehicle frame is permanently or semipermanently heavily loaded. For an air bag suspension, the system includes a refill valve device with a linkage that controls air pressure P1 in a first air bag to maintain a constant height of the frame over a location (the middle or first end) of the axle. The system also includes a valve assembly means that maintains an air pressure P2 in the second air bag at a predetermined pressure difference from air pressure in the first air bag. The valve assembly includes a first valve that flows air from a pressure source such as the first air bag to the second one when the pressure difference is more than the predetermine amount (e.g. 20 psi), and a second valve that vents air from the second air bag to the atmosphere when the pressure difference is less than the predetermined amount. The two valves can be placed with one inside the other. A valve member, or poppet of the second valve can move and forms a valve seat, in an arrangement that allows the use of a single, easily adjusted spring.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A differential valve system that maintains a predetermined pressure difference between an inlet pressure P1 and an outlet pressure P2, comprising:
a valve assembly which has walls that form an inlet port to receive the pressure P1 therein, and which forms a second port to supply air at a pressure P2 thereto;
said valve assembly includes a first valve which has a first passage with a first valve seat therealong, said first valve having a first valve member that is moveable rearward against said first valve seat and forward away from said first valve seat;
means for applying a first spring force that urges said first valve member rearward against said first valve seat with a predetermined first equivalent pressure;
said first port being connected to said rear face of said first valve member and said second port being connected to said front face of said first valve member, so the air pressure P2 at said second port equals the pressure P1 at said first port minus said predetermined air pressure equivalent.

2. The valve system described in claim 1 wherein:
said valve assembly includes a second valve with a discharge passage and with a second valve seat lying therealong and with upstream and downstream passage portions on opposite sides of said second valve seat, said second valve including a second valve member, said means for applying a second spring force that urges the second valve member upstream away from said discharge valve seat with a second equivalent pressure;
said upstream passage portion is connected to said first port to receive said outlet air pressure P2 so said air pressure P2 presses said second valve member towards said second valve seat;
said second valve member has a sealed upstream portion that is sealed against air leakage thereacross when said second valve member moves toward and away from said second valve seat, and said second valve member has an in-between portion lying between said second valve seat and said sealed upstream portion and connected to said second port to receive air at pressure P2 and discharge it to the environment when the difference P1−P2 decreases below the second equivalent pressure of said second spring force.

3. The valve system described in claim 2 including:
a valve housing which has walls that form said first and second ports and said first passage and said discharge passage, said first valve seal, and said upstream and downstream passage portions of said discharge passage;
of said first and second valve seats, one of them is formed by said housing and the other is formed by one of said valve members.

4. The valve described in claim 1 wherein said first valve member is moveable rearwardly against said first valve seat and forwardly away from said first valve seat, and including:
a control member which is slideable in a forward direction toward said first valve member and rearward away from it, said control member having a passageway that connects to said first port so air at said pressure P1 can flow through said passageway to a front end of said first valve member;
a control port which receives pressured air to push said control member forward against said first valve member to open said first valve, to thereby flow air at said pressure P1 to said second air bag regardless of the pressures P1 and P2.

5. The valve system described in claim 1 including a vehicle frame that is to be maintained in a horizontal orientation relative to a horizontal vehicle axle by controlling air pressure in first and second air bags that support first and second sides of the vehicle frame respectively on first and second end portions of the axle, despite a heavier load on said frame first end portion than said frame second end portion, comprising:
an air refill valve device having a linkage that senses the height of the frame above an axle location, said valve device connected to said first air bag to supply air thereto to maintain said height at a constant amount;
said first air bag is connected to said inlet part and supplies air at said pressure P1 to said inlet port of said valve assembly and said second port at pressure P2 is connected to said second air bag.

6. A differential valve system that maintains a predetermined pressure difference between an inlet pressure P1 and an outlet pressure P2 and that maintains a controlled pressure difference between said outlet pressure P2 and an exhaust pressure P3, comprising:
a housing having a passageway, an inlet port that receives fluid at said pressure P1 and that is connected to a rear portion of said passageway, an outlet port that carries fluid at said pressure P2 and that is connected to a middle portion of said passageway, and an exhaust port at said pressure P3 that is connected to a rear portion of said passageway;
first and second poppets that are each slideable along an axis in said passageway and that each has a rear surface exposed to fluid at said inlet port at pressure P1 and a front surface exposed to fluid at said outlet port at pressure P2;
said second poppet has a front end that forms a first valve seat and said first poppet is moveable forward off the first valve seat to flow fluid from said inlet port at pressure P1 to said outlet port at pressure P2;
a spring that biases said first poppet rearward to prevent opening said first valve seat unless the pressure difference P1−P2 exceeds a predetermined value;
said housing forms a second valve seat, said second poppet has a front portion that is moveable rearward off said second valve seal, and said outlet port opens to said front portion of said passageway that is forward of said second valve seat, so fluid in said passage that lies rearward of said second valve seat flows through said second valve seat toward said exhaust port;
a spring that biases said first poppet rearward to prevent opening said first valve seat unless the pressure difference P1−P2 exceeds a predetermined value, the rearward force of said spring being transmitted through said first poppet and said first valve seat to said second poppet.

7. The valve system described in clam 6 wherein:
said second poppet front end has a through hole extending along said passage and said spring extends through said through hole, and including a screw threadably mounted on said housing that presses a front end of the spring rearward and that can be turned to adjust spring preload.

8. A method for adjusting the outlet air pressure P2 at an outlet port in response to changes in pressure P1 of an inlet port, with excess air vented to an exhaust port, comprising:
spring biasing a first poppet rearwardly toward a first valve seat to urge the first valve seat closed, while applying said first air pressure P1 to a rear face of said first poppet, and while applying said outlet pressure P2 to a front face of the first valve member, so when the outlet air pressure P2 should fall, air pressure P1 at the inlet port flows into the outlet port to increase pressure thereat;
spring biasing a second poppet rearwardly away from a second valve seat to urge the second valve seat open, while applying said first air pressure P1 to a rear face of the second poppet to urge the second poppet closed against said second valve seat and while applying said second pressure to a front face of said second poppet to urge said second poppet away from said second valve seat;
coupling said exhaust port to a side of said second valve seat that is opposite said outlet port to vent air from said outlet port when said second poppet moves away from said second valve seat.

9. The method described in claim 8 including:
forming said first valve seat in a rear end of said second poppet and forming said second poppet front face with a larger diameter than said first valve seat;
said steps of spring biasing said first and second poppets include establishing a preloaded spring so it applies a rearward force to said first poppet while said first poppet presses forward against said second poppet through said valve seat.
